(19) United States
(12) Patent Application Publication
(10) Pub. No.: US 2012/0256850 A1
(43) Pub. Date: Oct. 11, 2012

(54) TOUCH PANEL WITH BUILT-IN ANTENNA

(75) Inventors: HSIN-NAN HU, Tu-Cheng (TW); WEN-LONG LI, Shenzhen City (CN); KAI-KUEI WU, Tu-Cheng (TW); HE-HUI YANG, Shenzhen City (CN); XIAO-BING GAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/158,472

(22) Filed: Jun. 13, 2011

(30) Foreign Application Priority Data
Apr. 7, 2011 (CN) 201110086271.X

(51) Int. Cl. G06F 3/041

(52) U.S. Cl. 345/173

(57) ABSTRACT

A touch panel includes a touch sensitive layer, a substrate opposite to the touch sensitive layer, a conductive layer arranged between the touch sensitive layer and the substrate, and an antenna. The substrate includes a central display area and a marginal bezel area surrounding the display area. The antenna is disposed at one side of the substrate that faces away from the conductive layer. The antenna is formed on the bezel area by spraying.

### BACKGROUND

1. Technical Field

The present disclosure relates to touch panel, and particularly, to a touch panel with built-in antenna.

2. Description of the Related Art

A portable electronic device, such as a mobile phone, often includes an antenna for transmitting/receiving information. Some of the conventional antennas are disposed at the edge of the main body of the electronic device, which increases the thickness of the electronic device.

Therefore, there is room for improvement within the art.

### BRIEF DESCRIPTION OF THE DRAWINGS

The components in the drawings are not necessarily drawn to scale, the emphasis instead being placed upon clearly illustrating the principles of a touch panel with built-in antenna. Moreover, in the drawings, like reference numerals designate corresponding parts throughout the several views.

FIG. 1 is a schematic view of a touch panel with integrated built-in antenna in accordance with an exemplary embodiment.

FIG. 2 is a schematic, exploded view of the touch panel in FIG. 1.

### DETAILED DESCRIPTION

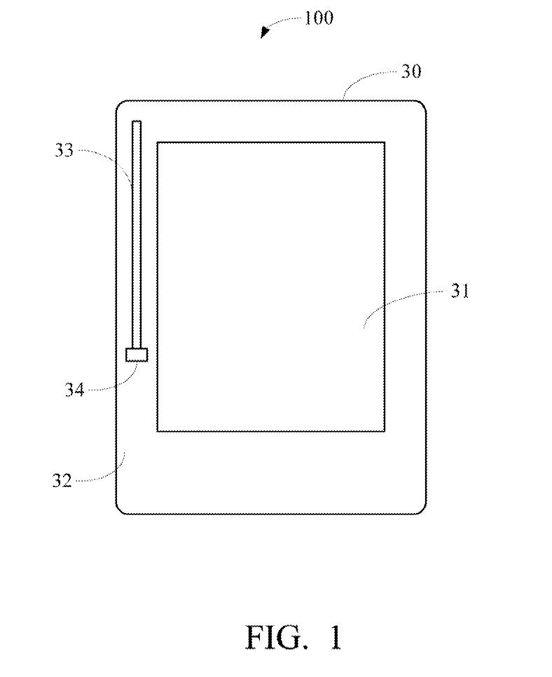

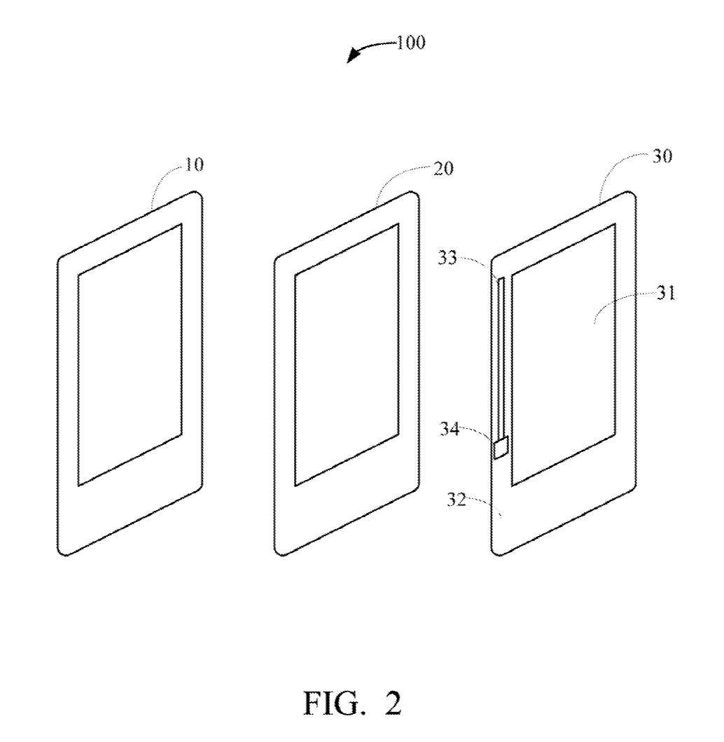

Referring to FIGS. 1 and 2, a touch panel 100 includes a touch sensitive layer 10, a substrate 30 opposite to the touch sensitive layer 10, and a conductive layer 20 between the touch sensitive layer 10 and the substrate 30. The substrate 30 includes a central display area 31 and a marginal bezel area 32 surrounding the display area 31.

In the embodiment, the touch panel 100 is a resistive touch screen (RTS). The touch sensitive layer 10 is an indium-tin oxide (ITO) layer. The substrate 30 includes a glass sheet and an ITO layer formed on the glass sheet.

An antenna 33 is disposed on a surface of the substrate 30 that faces away from the conducting layer 20. The antenna is formed on the bezel area 32 by spraying. In an alternative embodiment, the antenna 33 can be disposed on a surface of the touch layer 10, opposite to the conducting layer 20. The antenna 33 is disposed at a bezel area 32 adjacent to one edge of the substrate 30. In this embodiment, the antenna 33 is made of silver, and formed on the bezel area 32 by spraying technology. In this embodiment, the antenna 33 is an elongate strip, and extends along the lengthwise direction of the substrate 30. However, the configuration of the antenna 33 is not limited to this and can vary according to actual needs.

An contact 34 is formed at on one end of the antenna 33, and is electrically connected to a corresponding contact (not shown) on a circuit board (not shown).

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A touch panel comprising:
a touch sensitive layer;
a substrate opposite to the touch sensitive layer, the substrate including a central display area and a marginal bezel area surrounding the display area; and
a conductive layer arranged between the touch sensitive layer and the substrate;
an antenna disposed on a surface of the substrate that faces away from the conductive layer, wherein the antenna is formed on the bezel area by spraying.

2. The touch panel as recited in claim 1, wherein the antenna is made of silver.

3. The touch panel as recited in claim 1, wherein an antenna contact is formed on one end of the antenna.

4. The touch panel as recited in claim 1, wherein the touch sensitive layer is an indium-tin oxide (ITO) layer.

5. The touch panel as recited in claim 1, wherein the substrate includes a glass sheet and an ITO layer formed on the glass sheet.
